(19) United States
(12) Patent Application Publication
(10) Pub. No.: US 2024/0008579 A1
(43) Pub. Date: Jan. 11, 2024

(54) AIRBAG POUCH INCORPORATED IN A BACKPACK OR A GARMENT

(71) Applicant: In&Motion, Annecy (FR)

(72) Inventors: Valentin Honore, Annecy-Le-Vieux (FR); Remi Thomas, Annecy-Le-Vieux (FR)

(21) Appl. No.: 18/218,363

(22) Filed: Jul. 5, 2023

(30) Foreign Application Priority Data
Jul. 5, 2022 (FR) 2206863

(51) Int. Cl. A42B 3/12

(52) U.S. Cl. CPC A42B 3/122

(57) ABSTRACT

The invention relates to an airbag pouch for the personal protection of a user of an urban mobility vehicle such as for example a cycle, a scooter, a skateboard or roller skates. The airbag pouch comprises a closed body made from flexible and tear-resistant material forming an envelope, the envelope forming, in the inflated state:
two stiffening structures, located laterally on either side of the head of the user, each with two legs disposed one in front of, the other behind the shoulder of the user, and each a top loop, located on a side of the head of the user,
an arch connecting the tops of the top loops of the stiffening structures and forming, once inflated and with the top loops of the stiffening structures, a protection surrounding the head of the user.

The present invention relates to a deployable airbag pouch and its associated module, preferably intended for users of urban or “soft” mobility vehicles such as for example cycles, scooters, skateboards, roller skates, etc.

The increase in the number of urban mobility vehicles causes an increase in the number of accidents. These vehicles can achieve speeds which, although lower than the usual car speeds, can nevertheless cause potentially serious or even fatal injuries.

In particular electrically-assisted vehicles (bicycle or scooter) often travel at speeds above 20 km/h.

The most serious injuries, the most incapacitating and most able to cause death are injuries to the head of the user.

The cycle helmets that could protect the user from these injuries to the head are perceived to be constraining and unaesthetic, and contrary to the ideal of simplicity, spontaneity and immediacy offered by the urban mobility services of the self-service bicycle and scooter type.

The patent EP 1 947 966 describes an airbag forming protection for the head, which is deployed when an accident situation is detected. This airbag is integrated in a collar, ring or neck brace that the user passes and locks around their neck.

The airbag deploys from the collar and surrounds the head of the user.

The airbag is produced from tear- and abrasion-resistant material and, once inflated, damps impacts and protects the head of the user from any object that might damage it and cause potentially serious or even fatal injuries.

However, this airbag is integrated in a collar that is worn in addition to the clothing of the user. If said collar can be incorporated in a garment, this garment will necessarily be closed over the height of the body of the user. This garment will therefore consequently be of the jacket, gilet or pullover type.

Thus the users of urban mobility vehicles who do not wish to wear this type of garment, or if it is too hot to wear one, will have to separately transport and equip the collar or neck brace containing the airbag.

Many users will then the tempted to simply not wear the airbag and to leave it in a backpack or at home.

It would therefore be necessary to find a means of incorporating the airbag in garments or equipment in a more practical fashion, so that the users can take them without having dedicated equipment to take with them.

The documents JP 2011 24685, EP 3 901 016 and JP H09 66789 describe airbags for cycles, but the protection of the head of the user leaves something to be desired, in particular because of low rigidity of the portion surrounding the head.

In order to overcome the previously mentioned defects, the present invention proposes an airbag pouch for personal protection of a user of an urban mobility vehicle such as for example a cycle, a scooter, a skateboard or roller skates, comprising a closed body made from flexible and tear-resistant material forming an envelope,

characterized in that the envelope forms, in the inflated state:
two stiffening structures, located laterally on either side of the head of the user, each with a central portion in abutment on the shoulder extended by two legs disposed one in front of, the other behind the shoulder of the user, two legs disposed one in front of, the other behind the shoulder of the user, and each a top loop, located on a side of the head of the user,
an arch connecting the tops of the top loops of the stiffening structures and forming, once inflated and with the top loops of the stiffening structures, a protection surrounding the head of the user.

The legs of the stiffening structures of this airbag pouch form an engagement for deployment in position around the head of the user. These legs are easily incorporated in the straps of a backpack, or in a gilet or a garment that can have a low neck line and does not have to be closed around the neck.

The top loops furthermore stiffen the portion surrounding the head of the user.

The airbag pouch according to the invention may further have one or more of the following features.

The top loops of the stiffening structures can be produced in annular form, with a less thick central portion, preferentially planar.

As an alternative, the central portion can be at least partially inflated during the deployment at the middle, the central portion preferentially having a contraction and a baffle for limiting the circulation of the gas throughout an impact.

The legs of the stiffening structures located, in the deployed state, on the front of the chest of the user are advantageously curved with a curvature concave towards the front.

These legs then form an engagement that makes it possible, by lever effect, to prevent the arch coming into engagement with the head or the nape of the user.

The legs of the stiffening structures located, in the deployed state, on the front of the chest of the user can include transverse pads which, once inflated, form at least one protective pectoral plate.

This pectoral plate protects the chest of the user and will absorb an impact, for example against the ground.

The legs of the stiffening structures located, in the deployed state, at the rear of the user can include transverse pads which, once inflated, form at least one protective dorsal plate.

This dorsal plate protects the back of the user and will absorb an impact, for example against the ground.

These transverse pads can furthermore be connected to the corresponding leg of the stiffening structure by a contraction for limiting the circulation of the gas to the leg of the stiffening structure throughout an impact, and can include two cords, the ends of which are attached to a high point and a low point of one of the front legs of the stiffening structures, and passing through a sliding connection located at the middle of the free end of the pectoral plate connected to the front leg, which, in the inflated state, folds the pectoral plate against the torso of the user.

These contractions between the leg of the stiffening structure and these transverse inflatable pads operate as hinges that make it possible to maintain the angle between these two airbag parts during inflation.

The arch may include baffles, stiffening the arch in the deployed state, forming preferential folding lines and limiting the circulation of the gas in the event of impact on this arch.

The airbag pouch advantageously includes two gas-inlet conduits each emerging in one of the legs of the stiffening structures located, in the deployed state, at the back of the user, in the upper third of said leg of the stiffening structures.

The invention also relates to the airbag, for the personal protection of a user of an urban mobility vehicle, comprising:
an actuator, configured to detect accident situations,
at least one cartridge, which is triggered when the actuator detects an accident situation,
   characterized in that it includes an airbag pouch as mentioned previously, inflated by the at least one cartridge when it is triggered.

Finally, the invention also relates to the backpack, characterized in that it includes said airbag, wherein the front legs of the stiffening structures are located, in the folded state, in housings provided in straps of the backpack, the housings being closed by disengageable mechanical links, which open under the action of the inflation of the airbag pouch.

These disengageable mechanical links may particular comprise at least one from: a disengageable zip closure, fusible stitching, press studs, self-gripping strips with loops and textile hooks.

The backpack may comprise a pack body including a pack body close to the back of the user incorporating the airbag mentioned, and a removable separate part forming a storage space.

Other features and advantages will appear upon reading the following description of the figures, among which:

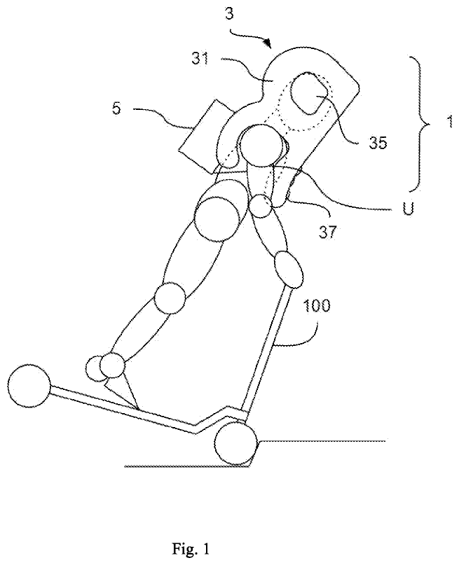

FIG. 1 is a profile view of a user of a scooter in the process of falling, with an airbag according to the invention in the deployed state,

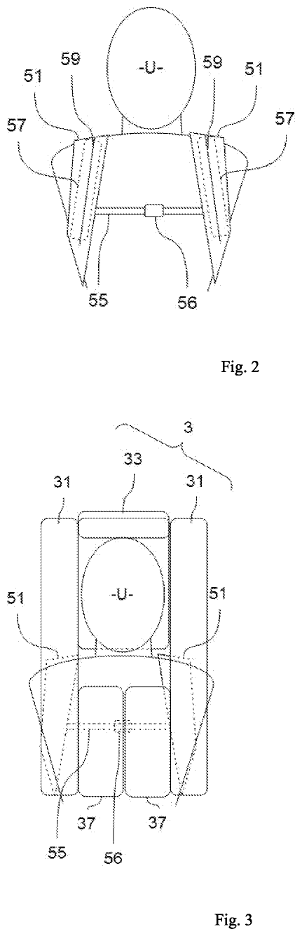

FIG. 2 is a front view of a user wearing a backpack containing the airbag according to the invention, in the folded state,

FIG. 3 is a schematic front view of a user wearing a backpack containing the airbag according to the invention, in the deployed state,

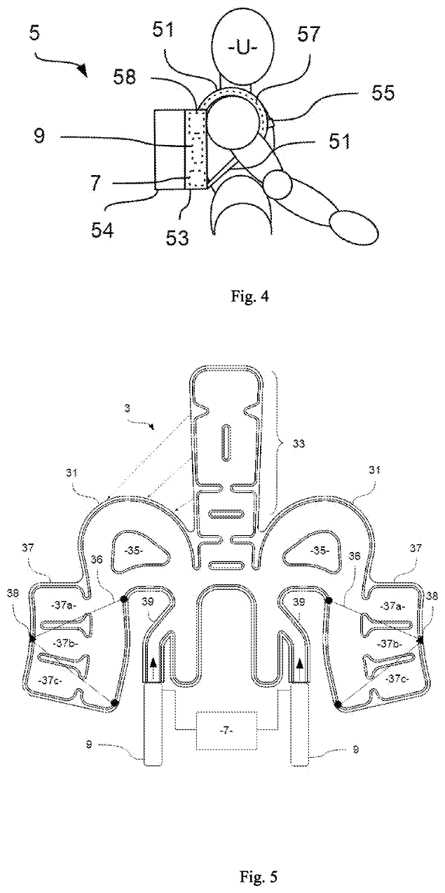

FIG. 4 is a profile schematic view of a user wearing a backpack containing the airbag according to the invention, in the folded state,

FIG. 5 is a view of the airbag out of the backpack,

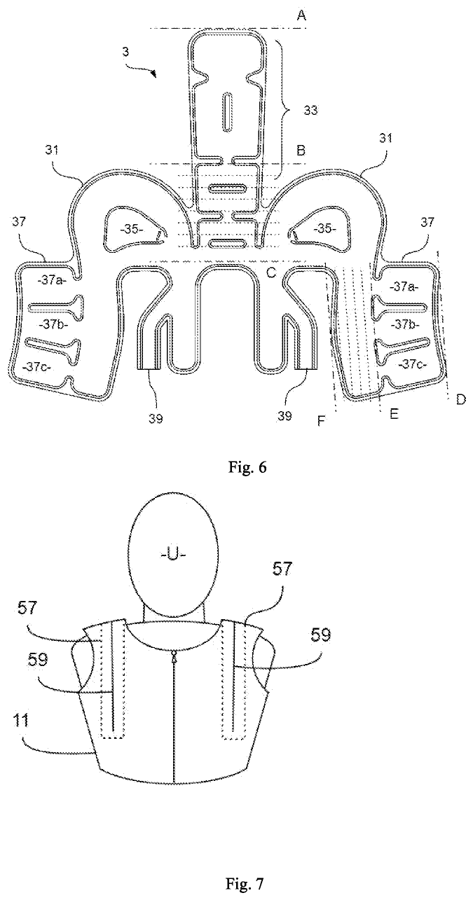

FIG. 6 is a fashion pattern of an alternative embodiment of an airbag pouch according to the invention,

FIG. 7 is a schematic front view of a user wearing a gilet containing the airbag according to the invention, in the folded state.

The figures are given by way of illustrative and non-limitative examples. Alternative embodiments can be obtained by slightly varying or by combining the embodiments shown.

FIG. 1 is a schematic representation of a user U in the process of falling from an urban mobility machine 100, here a scooter. Other urban mobility machines can be bicycles, skateboards, gyropods and variants thereof, in particular with electrical assistance or motorization.

The user U is in the process of falling, for example following a collision of the urban mobility machine 100 with an obstacle, here a step or a pavement.

The user U is equipped with an airbag 1, the pouch 3 of which is deployed. The pouch 3 of the airbag 1 surrounds in particular the head of the user U, shown in broken lines. The pouch 3 is in particular contained, in the folded and deflated state, in a backpack 5.

The chest of the user U is shown in front view in FIG. 2 with the airbag 1 the pouch 3 of which is folded, and in FIG. 3 with a deployed pouch.

The pouch 3 includes a closed body, produced from flexible material, resistant in particular to tears and high temperatures, of the type used for normal airbags, for example automobile airbags.

The material of the pouch 3 is for example a polyamide 6.6 or polyester textile, woven and coated with silicone or laminated with an impervious film.

The airbag is advantageously produced by weaving a single piece (“one piece woven”), i.e. woven overall in a one and the same piece. This makes it possible to greatly increase its gastightness.

The body of the pouch 3 is composed of a plurality of distinct volumes, separated by contractions or elbows.

The body of the pouch 3 includes in particular two stiffening structures 31, located laterally on either side of the head of the user U and in the form of an R. The form of the stiffening structure 31 in an R shape is apparent in FIG. 1, where the deployed pouch 3 is observed from the side. The arrangement thereof on each side of the head of the user U is apparent in FIG. 3, which is a front view.

These stiffening structures 31 each include two pads forming legs of the R, disposed one in front of and the other behind the shoulder of the user U. An annular pad forms the top loop of the R, located on one side of the head of the user U.

According to other embodiments, the stiffening structure 31 can have comparable forms: in an A, in an X or in a K, always with two bottom legs and a top part located on the side of the head of the user U.

The body of the pouch 3 furthermore includes an arch 33 connecting the tops of the top loops of the stiffening structures 31, and covering, in the deployed state, at least the nape and the top of the cranium of the user U. The arch 33 and the top loops of the stiffening structures 31 form in the inflated state a protection surrounding the head of the user U.

The legs of the stiffening structure 31 form an engagement against the chest and the back of the user U. Their engagement against the chest and the back then ensures the correct deployment of the pouch 3, in particular without the arch 33 locking at the nape of the user U. The legs of the stiffening structure 31 located in the deployed state on the front of the chest of the user U are advantageously curved with a concave curvature towards the front.

The top loops of the stiffening structures 31 are produced in annular form, with a central portion 35 that is preferably planar in the inflated state. This recessed central portion 35 provides an engagement on the side of the head of the user U.

The legs of the stiffening structures 31 that are located on the front of the chest of the user U are extended as plates 37, transverse in the deployed state, forming pectoral protection.

Other embodiments, not shown, can have additional flaps for protecting other parts of the body of the user U: in the back, starting from the back legs of the stiffening structure 31 and forming dorsal protection, shoulder pieces, hip protector, etc. Said flaps are connected to the stiffening structures 31 and extend therefrom during inflation.

FIGS. 2 and 4 show in more detail the backpack 5 and the way in which the airbag 3 is incorporated therein.

In FIG. 2, the user is seen in front view, and only the straps 51 of the backpack 5, passed around the shoulders of the user U, are visible.

FIG. 4 shows the user U carrying the backpack 5 in profile.

The backpack 5 furthermore includes a pack body 53 that the user U carries on his back. The straps 51 are connected to the pack body 53 and hold it against the back of the user U when it is worn.

The pack body 53 contains in particular a part of the pouch 3, and the mechanism for actuating the airbag 1: an actuator 7 that detects an accident situation, and one or more cartridges 9, to which the actuator 7 is connected.

When the actuator 7 detects an accident situation, it triggers the cartridge or cartridges 9, which inflates the pouch 3.

The actuator 7 is for example provided with inertial sensors, with a control unit configured to distinguish, in real time, among the signals coming from the inertial sensors, acceleration markers particular to the accident situations in which the pouch 3 must be deployed.

In FIG. 2, the backpack 5 includes a pectoral strap 55, closed by a loop 56. The pectoral strap 55 includes in particular a switch actuated by the closure of the loop 56. The actuation of the switch activates the actuator 7, for example by closing the supply circuit of the inertial sensors.

The cartridges 9 for example pyrotechnic cartridges, in which an explosive reaction generates the gas that will inflate the pouch 3. As an alternative, the cartridges 9 may be compressed-gas bottles, with a punch controlled by the actuator 7.

FIG. 5 shows the components of the airbag 1 out of the backpack 5. The pouch 3 of the airbag 1 is furthermore shown by its flat pattern. For assembling the finished pouch 3 the side edges of the portion forming the arch 33 are sewn and/or glued and/or welded on the top curved edge of the top loops of the stiffening structures 31 (broken arrows in FIG. 5).

The pouch 3 of the airbag 1 advantageously includes two gas-inlet conduits 39 each emerging in one of the legs of the stiffening structures 31 located, in the deployed state, on the back of the user U, at the upper third of said leg.

The plates 37 forming pectoral protection include transverse pads 37a, 37b, 37c that are connected to the front leg of the stiffening structure 31 each by a contraction making it possible both to limit the circulation of the gas to the front leg of the R throughout an impact on the pectoral part but also to facilitate the formation of the elbow of said transverse pads 37a, 37b, 37c with respect to the leg of the stiffening structure 31.

A cord 36 structures and holds in position each of the plates 37 forming pectoral protection.

The cords 36 have their ends attached to the front leg of the stiffening structure 31, at a high point and a low point of said leg, for each of the ends of each cord 36.

The cords 36 pass through a sliding connection 38, located at the middle of the free end of the plate 37 that is associated therewith. The cords 36 can in particular slide in the sliding connection 38, which is for example produced by means of a stitched loop through which the cord 36 passes.

The cord 36 has a length such that, when the pouch 3 is inflated, it pulls on the free end of the plate 37 via the sliding connection 38. By pulling on the free end of the plate 37, the cord 36 folds said plate against the torso of the user U.

The cords 36 may in particular be elastic, and tensioned under the effect of the inflation.

The arch 33 has baffles, formed by producing stitched, welded or glued transverse strips, on the path of the gas entering the volume of the arch 33, alternated with contractions.

These baffles stiffen the arch in the deployed state, while forming favored points for emergence of folds curving the arch 33 to enable it to follow the curvature of the loops of the stiffening structure 31. Furthermore, the baffles limit the circulation of the gas towards the dorsal part of the airbag when there is an impact on the part above or behind the head. It is then possible to combine good impact performance and small inflated thickness for this part of the pouch 3.

A part of the pouch 3, in particular the legs of the stiffening structures 31, are located, in the folded state, in housings 57 provided in the straps 51 of the backpack 5. These housings 57 are closed by disengageable mechanical links 59, such as a disengageable zip closure, fusible stitching, press studs, self-gripping strips with loops and textile hooks. These mechanical links 59 are opened under the action of the inflation of the pouch 3 of the airbag 1.

The part of the pouch 3 forming, in the inflated state, the arch 33 and the top loops of the stiffening structure 31 is contained in a dorsal housing 58 of the backpack 5, close to the nape and head of the user U. This dorsal housing 58 is also closed by disengageable mechanical links (not shown). When the pouch 3 is inflated, the disengageable mechanical links 59 slacken. The housings 57 of the straps 51 and the dorsal housing 58 of the pack body 53 open, which releases the pouch 3, which can then deploy.

The stiffening structures 31 deploy and inflate the most quickly, since they are connected first to the cartridges 9, with a large and almost uniform cross section over the whole of their volume, without any obstacle to the circulation of air.

The top loops of the stiffening structures 31 are folded in the dorsal housing 58 of the backpack 5 with the arch 33, and take a little longer to inflate completely, in particular with sufficient pressure to stiffen them.

According to the particular embodiments in FIG. 4, the dorsal housing 58, the actuator 7 and the cartridges 9 are contained in the pack body 53 close to the back of the user U.

The pack 5 furthermore includes a separate portion 54, removable for example by means of a zip fastener, which forms a storage space for the possessions of the user, and which is interchangeably attached against the rest of the backpack 5, including the pack body 53 containing the airbag 1 and the straps 51.

The more rapid inflation of the stiffening structures 31, in particular of the front and rear legs, enables them to stiffen first, and then to form a base and an engagement for the correct deployment of the rest of the pouch 3.

The top loops of the stiffening structures 31 form a guide in the deployment of the arch 33, with which they are in engagement, which ensures that the arch 33 does not come into contact with the nape or the back of the head of the user U.

In the embodiment in FIG. 5, the central portion 35 at the middle of the loops of the stiffening structures 31 is planar, without inflation.

FIG. 6 shows an alternative embodiment of the pouch 3, shown by its flat pattern in a similar manner to FIG. 5.

The pouch 3 in FIG. 6 differs from the one in FIG. 5 in that the central portions 35 of the loops of the stiffening structures 31 are here produced in the form of pouches that inflate when the airbag 1 deploys.

The central portions 35 include here a contraction followed by baffles, to limit the circulation of the gas towards the outside of this central portion 35 at the time of an impact. The central portion 35 are of lesser thickness compared with the loop, to form a housing for the temple and the ear of the user U.

Lines A, B, C, D, E and F illustrate in FIG. 7 the folding of the deflated pouch 3 to put it back in the backpack 5, for example following a deployment.

The first line A is located at the end of the portion of the pouch 3 forming the arch 33, and runs along the extreme edge of this portion. The line B is located at the end of the baffles limiting the entry of air into the arch 33, and is parallel to the line A.

The line C is located at the base of said portion of the pouch 3 forming the arch 33, at the bottom edge of the segment of the pouch 3 connecting the two rear legs of the stiffening structures 31.

The fourth line D is located at the free end of the pectoral plates 37. The fifth line E is located at the contractions of the pads 37a, 37b, 37c at the base of the pectoral plates 37, and is parallel to the fourth line D. The sixth line F is at the opposite edge to the pectoral plates 37 of the front leg of the stiffening structure 31, parallel to the fourth and fifth lines D, E.

The folding of the pouch 3 is then advantageously implemented as follows.

Firstly, the portion of the pouch 3 between the lines A and B is wound on itself. The portion of the pouch 3 between the lines B and C is then folded in an accordion or zigzag, which is shown by broken folding lines, parallel and regularly distributed between the lines B and C.

This portion of the pouch corresponding to the arch 33 and to the top loops of the stiffening structures is then inserted in the dorsal housing 58 of the backpack 5.

Next, the pectoral plates 37 are wound on themselves, from the line D to the line E. The front legs of the stiffening structures are then folded in an accordion, from the line E to the line F, which is represented by broken folding lines, parallel and regularly distributed between the lines E and F.

These portions of the pouch 3 corresponding to the front legs and to the pectoral plates 37 are then inserted in the housings 57 in the straps 51 of the backpack 5.

In particular, the portions folded in an accordion (from the lines B to C and E to F) will be deployed more quickly than the wound portions (lines A to B and D to E), which improves the kinematics of the deployment.

FIG. 7 shows an alternative embodiment, in which the airbag 1 is incorporated in a gilet 11 instead of the backpack 5. The housings 57 closed by the mechanical fuses 59 are here located at the shoulders of the user U, rather than in the straps 51, but directly in the gilet 11, with a similar arrangement compared with the embodiment including a backpack 5.

The actuator 7 and the cartridges 9 are for example disposed in a dorsal part (not shown), as well as the dorsal housing 58 containing the portion of the pouch 3 corresponding to the loops and to the arch 33.

The pouch 3 of the airbag 1 according to the invention is therefore easily integrated in a backpack 5 with a normal shape. It takes advantage of the presence of the straps 51, in which the portion of the pouch 3 corresponding to the front legs and to the pectoral plates 37 is inserted in the housings 57.

No dedicated garment is required, in particular of the neck brace or collar type. The pouch 3 however also allows easy incorporation in a normal garment (gilet, jacket, etc, see FIG. 7).

Finally, the pouch 3 according to the invention has continuous and improved deployment kinematics compared with the prior art. This is because the stiffening structures 31 are the first to inflate with a sufficient cross section to become semi-rigid.

They next form a structure from which the other elements (arch 33, pectoral plates 37, dorsal protection, etc) deploy, said stiffening structures 31 furthermore forming an engagement for the deployment of these other elements, which prevents them jamming against a part of the body of the user U.

1. Airbag pouch for personal protection of a user (U) of an urban mobility vehicle such as for example a cycle, a scooter, a skateboard or roller skates, comprising a closed body made from flexible and tear-resistant material forming an envelope, characterized in that
the envelope forms, in an inflated state:
two stiffening structures, located laterally on either side of the head of the user (U), each with a central portion in abutment on the shoulder of the user (U) extended by two legs disposed one in front of, the other behind the shoulder of the user (U), and each a top loop, located on a side of the head of the user (U),
an arch connecting the tops of the top loops of the stiffening structures and forming, once inflated and with the top loops of the stiffening structures, a protection surrounding the head of the user (U).

2. Airbag pouch according to claim 1, characterized in that the top loops of the stiffening structures are produced in annular form, with a less thick central portion.

3. Airbag pouch according to claim 1, characterized in that the legs of the stiffening structures located, in a deployed state, on the front of the chest of the user (U) are curved with a curvature concave towards the front to bear on the user (U).

4. Airbag pouch according to claim 1, characterized in that the legs of the stiffening structures located, in the deployed state, on the front of the chest of the user (U) include transverse pads which, once inflated, form protective pectoral plates.

5. Airbag pouch according to claim 4, characterized in that the transverse pads are connected to the corresponding leg of the stiffening structure by a contraction forming a folding zone of the protective pectoral plate with respect to the front leg of the stiffening structure, and in that it includes two cords, the ends of which are attached to a high point and a low point of one of the front legs of the stiffening structures, and passing through a sliding connection (38) located at the middle of the free end of the pectoral plate connected to the front leg.

6. Airbag pouch according to claim 1, characterized in that the arch includes one or more baffles, stiffening the arch in the deployed state, forming preferential folding lines and limiting the circulation of the gas towards a dorsal part of the pouch throughout an impact on the part above or behind the head of the user (U).

7. Airbag pouch according to claim 1, further comprising two gas-inlet conduits each emerging in one of the legs of the stiffening structures located, in the deployed state, on the back of the user (U), at the upper third of said leg of the stiffening structures.

8. Airbag for the personal protection of a user of an urban mobility vehicle such as for example a cycle, a scooter, a skateboard or roller skates, comprising:
an actuator, configured to detect accident situations,
at least one cartridge, which is triggered when the actuator detects an accident situation,
characterized in that it includes an airbag pouch according to claim 1, inflated by the at least one cartridge when it is triggered.

9. Backpack, characterized in that it includes an airbag according to claim 8, and in that the front legs of the stiffening structures are located, in the folded state, in housings provided in straps of the backpack, the housings being closed by disengageable mechanical links, which open under the action of the inflation of the pouch.

10. Backpack according to claim 9, characterized in that the disengageable mechanical links comprise at least one from: a disengageable zip closure, fusible stitching, press studs, self-gripping strips with loops and textile hooks.

11. Backpack according to claim 9, characterized in that it includes a pack body close to the back of the user (U) incorporating the airbag according to claim 8, and a removable separate part forming a storage space.
